(19) United States
(12) Patent Application Publication
(10) Pub. No.: US 2023/0020295 A1
(43) Pub. Date: Jan. 19, 2023

(54) CHEMICAL INDICATOR

(71) Applicant: American Sterilizer Company, Mentor, OH (US)

(72) Inventor: Kathleen A. Fix, Willoughby, OH (US)

(21) Appl. No.: 17/779,824

(22) PCT Filed: Oct. 21, 2020
(86) PCT No.: PCT/US2020/056570

§ 371 Date: May 25, 2022

Related U.S. Application Data
(60) Provisional application No. 62/939,707, filed on Nov. 25, 2019.

(51) Int. Cl. G01N 21/78; G01N 31/22

(52) U.S. Cl. CPC G01N 21/78; G01N 31/226

(57) ABSTRACT

This invention relates to a chemical indicator, comprising: a non-cellulosic backing layer; a non-cellulosic cover layer overlying the backing layer; the backing layer and/or the cover layer comprising a gas permeable polymeric film; a non-cellulosic wicking material positioned between the backing layer and the cover layer; a dye composition positioned between the backing layer and the cover layer and in contact with or nearly in contact with the wicking strip, the dye composition comprising an indicator dye which changes color in the presence of hydrogen peroxide, and a base medium, which melts at a temperature in the range from about 45° C. to about 65° C.; the cover layer including a transparent portion to permit observation of the wicking material; and an adhesive for adhering the cover layer to the backing layer. The chemical indicator may be referred to as a moving front chemical indicator. A process for conducting a vaporous hydrogen peroxide (VHP) sterilization process using the foregoing chemical indicator is disclosed.

### TECHNICAL FIELD

This invention relates to chemical indicators and, more particularly, to moving front chemical indicators for determining whether appropriate sterilization parameters are met using vaporous hydrogen peroxide (VHP) sterilization processes.

### BACKGROUND OF THE INVENTION

There are multiple types of chemical indicators used to determine whether or not appropriate sterilization parameters are met by a sterilization process. Type 1 indicators show simply that the item has been processed by the sterilization process. Type 2 indicators are specialized devices, used to indicate proper operation of the sterilizer. Type 3 indicators react to a single parameter (e.g., temperature). Type 4 indicators react to two or more parameters (e.g., temperature and time). Type 5 indicators react to all appropriate parameters of the sterilization process and are correlated with the results for a biological indicator (BI) used to monitor the sterilization process. Type 5 indicators are also known as integrating indicators. Type 6 indicators are emulators and target a specific sterilization cycle.

### SUMMARY OF THE INVENTION

The desired parameters to observe for VHP sterilizations are hydrogen peroxide concentration, temperature, time, and plasma presence (if applicable). The sterilization device, its parameters, and the sterilant used to sterilize articles with VHP has made it difficult to produce certain types of chemical indicators for the sterilization device. The interior of the sterilization device (chamber where sterilization takes place) is subjected to multiple atmospheric and vacuum cycles, humidity and sterilant concentration changes. Moving front chemical indicators are chemical indicators that comprise a dye composition positioned on a strip of wicking material, wherein the dye composition wicks along the strip of wicking material and changes color in response to changes in one or more parameters of a sterilization process (e.g., time, temperature, etc.). At present, no moving front chemical indicators are available for VHP sterilization processes. Type 1, 3, and 4 indicators are currently used for VHP processes. No Type 5 or 6 chemical indicators are available for VHP sterilization processes.

Moving front chemical indicators for steam sterilization are available. These chemical indicators employ dye compositions that are solid at room temperature and melt under conditions of high temperature and humidity. These compositions include salicylamide, ethoxy benzamide, and a mixture of 2-ethoxy-3′-chloro-N,N-diphenylurea and 1,4,5,8-tetra-aminoanthraquinone. These steam sterilization indicators also use colored dyes to make the front visible to users, a wicking material for front movement, and various binders for stability. The melting points of these components (121° C.-135° C.) are not amenable to use in a lower temperature (45° C.-65° C.) VHP sterilization processes. These low temperature requirements make it difficult to find appropriate matrices for the VHP chemical indicators. Also, shipping and handling of such chemical indicators for VHP processing is problematic (consider Phoenix, Arizona in summer). In addition, the oxidative nature of hydrogen peroxide presents challenges in chemical indicator manufacture (no cellulosics for wicking or other indicator components due to flammability considerations) and the potential for dyes that might be used to show the movement of the front is limited (hydrogen peroxide has a bleaching effect).

The problem, therefore, is to provide a suitable chemical indicator to monitor the progress of a VHP sterilization process. This problem is solved with this invention. This invention relates to a chemical indicator, comprising: a non-cellulosic backing layer; a non-cellulosic cover layer overlying the backing layer; the backing layer and/or the cover layer comprising a gas permeable polymeric film; a non-cellulosic wicking strip positioned between the backing layer and the cover layer; a dye composition positioned between the backing layer and the cover layer and in contact with or nearly in contact with the wicking strip, the dye composition comprising an indicator dye which changes color in the presence of hydrogen peroxide, and a base medium, which melts at a temperature in the range from about 45° C. to about 65° C.; the cover layer including a transparent portion to permit observation of the wicking strip; and an adhesive for adhering the cover layer to the backing layer. This chemical indicator may be referred to as a moving front chemical indicator.

### BRIEF DESCRIPTION OF THE DRAWINGS

In the annexed drawings, like parts and like features have like designations.

FIG. 1 is a plan view of a moving front chemical indicator in accordance with an embodiment of the present invention, the chemical indicator including a cover layer, a backing layer, a non-cellulose wicking material in the form of a rectangular strip, and a dye composition in the form of a pellet, the cover layer including a transparent portion which allows for visual observation of the wicking material.

FIG. 2 is a plan view of the chemical indicator shown in FIG. 1 with the cover layer removed.

FIG. 3 is a plan view of a moving front chemical indicator in accordance with an alternative embodiment of the present invention, the chemical indicator including a cover layer which is partially cut away for illustrative purposes, a backing layer, a non-cellulose wicking material in the form of a circular layer, and a dye composition in the form of a pellet, the cover layer including a transparent portion which allows for visual observation of the wicking material.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “X and/or Y,” when used in conjunction with open-ended language such as “comprising” can refer, in one embodiment, to X without Y (optionally including elements other than Y); in another embodiment, to Y without X (optionally including elements other than X); in yet another embodiment, to both X and Y (optionally including other elements); etc.

The word “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” may refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The phrase “at least one,” in reference to a list of one or more elements, should be understood to mean at least one element selected from any one or more of the elements in the list of elements, but not necessarily including at least one of each and every element specifically listed within the list of elements and not excluding any combination of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of X and Y” (or, equivalently, “at least one of X or Y,” or, equivalently “at least one of X and/or Y”) can refer, in one embodiment, to at least one, optionally including more than one, X, with no Y present (and optionally including elements other than Y); in another embodiment, to at least one, optionally including more than one, Y, with no X present (and optionally including elements other than X); in yet another embodiment, to at least one, optionally including more than one, X, and at least one, optionally including more than one, Y (and optionally including other elements); etc.

The transitional words or phrases, such as “comprising,” “including,” “carrying,” “having,” “containing,” “involving,” “holding,” and the like, are to be understood to be open-ended, i.e., to mean including but not limited to.

The term “sterilization” is often taken to refer to a process wherein a total absence of living test organisms is achieved. However, this term is also used herein to refer to processes that are less rigorous than sterilization processes. These may include, for example, disinfection, sanitization, decontamination, cleaning, and the like. The sterilant used in the sterilization process comprises vaporous hydrogen peroxide (VHP).

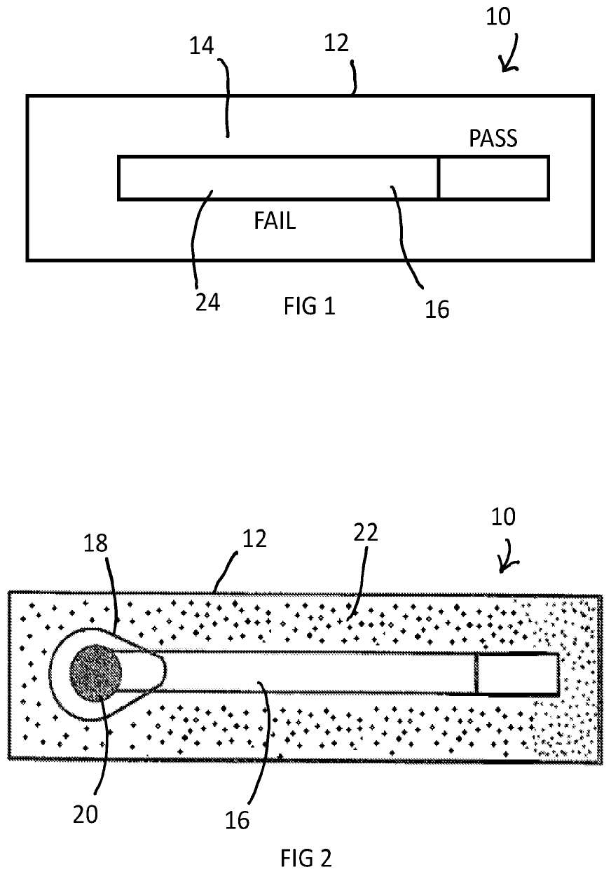

Referring to FIGS. 1 and 2, chemical indicator 10 includes backing layer 12 and cover layer 14 which overlies and is adhered to backing layer 12. Wicking material 16, which is in the form of a rectangular strip, is positioned between the backing layer 12 and cover layer 14. The backing layer 12 includes depression 18. A dye composition in the form of a pellet 20 is positioned in depression 18. The dye composition comprises an indicator dye, optionally a contrast dye, and a base medium. The dye composition is adapted to wick onto and along wicking material 16 in response to the melting of the base medium. Adhesive layer 22 is positioned between backing layer 12 and cover layer 14 and adheres cover layer 14 to backing layer 12. Cover layer 14 includes transparent portion 24 which allows for observation of the wicking material 16. The cover layer 14 includes the markings “FAIL” and “PASS” to indicate whether the VHP sterilization process being observed has failed or passed as evidenced by the change in color of the indicator dye. The cover layer 14 may also include other indicia.

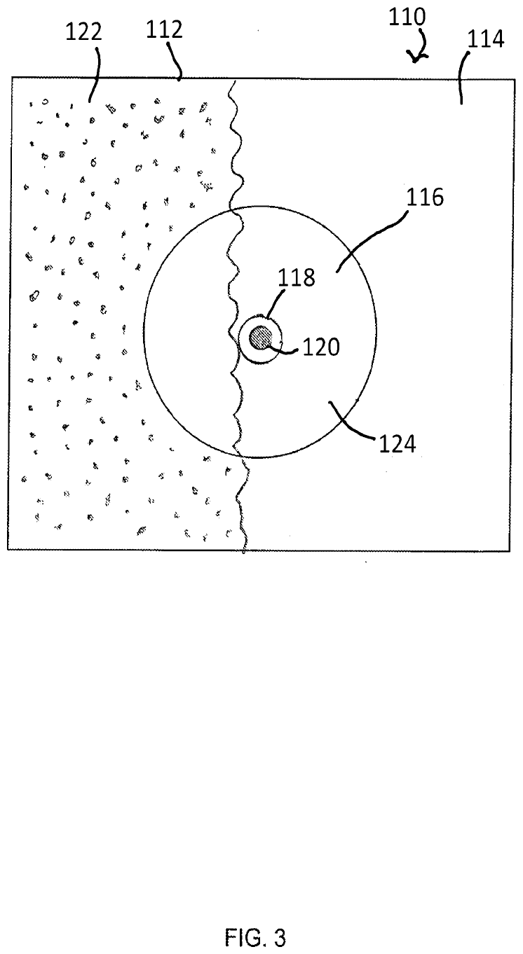

An alternative embodiment of the chemical indicator is shown in FIG. 3. Referring to FIG. 3, chemical indicator 110 includes backing layer 112 and cover layer 114 which overlies and is adhered to backing layer 112. In FIG. 3, cover layer 114 is partially cut away for illustrative purposes. In actual use cover layer 114 would extend over the entire length and width of backing layer 112. The backing layer 112 includes depression 118. Wicking material 116 is positioned between the backing layer 112 and cover layer 114. A dye composition in the form of a pellet 120 is positioned in depression 118. The dye composition comprises an indicator dye, optionally a contrast dye, and a base medium. The dye composition is adapted to wick onto and along wicking material 116 in response to the melting of the base medium. Adhesive layer 122 is positioned between backing layer 112 and cover layer 114 and adheres cover layer 114 to backing layer 112. Cover layer 114 includes a transparent portion 124 which allows for observation of the wicking material 116. The cover layer 114 may include the markings “FAIL” and “PASS” to indicate whether the VHP sterilization process being observed has failed or passed as evidenced by the change in color of the indicator dye. The cover layer 114 may also include other indicia.

The backing layer 12 or 112 may be constructed of a metal foil, for example, an aluminum foil such as a dead soft aluminum, or a non-cellulosic polymeric film, for example, a polyolefin, polyester, polyamide, vinyl chloride polymer, polyacrylate, polycarbonate, or a mixture of two or more thereof. The polymeric film may comprise a polyethylene, polypropylene, polyethylene terephthalate, copolymers of polyethylene terephthalate, polybutylene terephthalate, polyvinyl chloride, polyvinylidene fluoride, ethylene vinyl alcohol, ethylene vinyl acetate, polychloroprene, polyisoprene, polytetrafluoroethylene, poly (trifluorochloroethylene), polymethacrylate, poly (meth) methacrylate, or a mixture of two or more thereof. The polymeric film may comprise mylar. The backing layer 12 may have any desired length and width. The length of the backing layer 12 may be in the range from about 2 to about 15 centimeters (cm), or from about 5 to about 10 cm. The width of the backing layer 12 may be in the range from about 0.5 to about 10 cm, or about 2.5 to about 7.5 cm. The backing layer 112 may be in the form of a square with each side having a length in the range from about 2 to about 10 cm, or from about 5 to about 10 cm. The backing layer 12 or 112 may have a thickness in the range from about 25 to about 1300 micrometers, or from about 75 to about 250 micrometers.

The cover layer 14 or 114 may comprise a non-cellulosic, transparent polymeric film. The cover layer 14 or 114 may include an opaque coating or film layer adhered to it. The cover layers 14 and 114 include transparent portions 24 and 124, respectively, which allow for visual observation of the wicking materials 16 and 116. The opaque film layer or coating may include various indicia thereon, for example, the words “PASS” and “FAIL” as indicated above. The polymeric film used as the cover layer 14 or 114 may comprise a polyolefin, polyester, polyamide, vinyl chloride polymer, polyacrylate, polycarbonate, or a mixture of two or more thereof. The polymeric film may comprise a polyethylene, polypropylene, polyethylene terephthalate, copolymers of polyethylene terephthalate, polybutylene terephthalate, polyvinyl chloride, polyvinylidene fluoride, ethylene vinyl alcohol, ethylene vinyl acetate, polychloroprene, polyisoprene, polytetrafluoroethylene, poly (trifluorochloroethylene), poly methacrylate, poly (meth) methacrylate, or a mixture of two or more thereof. The cover layer 14 or 114 may comprise polypropylene. The cover layer 14 may have any desired length and width. The length may be in the range from about 2 to about 15 cm, or from about 5 to about 10 cm. The width may be in the range from about 0.6 to about 10 cm, or about 2.5 to about 7.6 cm. The cover layer 114 may be in the form of a square with each side having a length in the range from about 2 to about 10 cm, or from about 5 to about 10 cm. The cover layers 14 and 114 may have thicknesses in the range from about 10 to about 250 micrometers, or from about 25 to about 75 micrometers.

The backing layers 12 and 112 and/or the cover layers 14 and 114 may be sufficiently gas permeable to permit VHP to penetrate the backing layer 12 or 112 and/or cover layer 14 or 114 and contact the wicking material 16 or 116.

The adhesive layer 22 or 122 may comprise an acrylic adhesive. The pellet 20 or 120 may have any desired shape, for example, spherical, cylindrical, etc. and may comprise a base medium in which an indicator dye and optionally a contrast dye reside. The mass of the pellet 20 or 120 may be from about 20 to about 1000 milligrams (mg), or from about 40 to about 250 mg.

The base medium advantageously melts at a temperature in the range from about 45° C. to about 65° C. The base medium may comprise polyethylene glycol (PEG) of molecular weight from about 1000 to about 4000, polyethylene glycol monomethyl ether (PEGMME) of molecular weight of about 1900. The base medium may comprise deep eutectic solids (DES), natural DES, ionic liquids, and other low melting point polymers (e.g., thermoplastic polymers). Waxes which melt in the above-indicated temperature range may be used.

The indicator dye may comprise a redox indicator which reacts and changes color in the presence of VHP. These dyes may include lissamine green. Lissamine green turns pale to colorless in the presence of VHP. Other redox indicating materials that may be used include resazurin, resorufin, diphenylamine sulfonate, diphenylamine, nitrodiphenylamine, methyl orange, neutral red, methylene blue, crystal violet, iron(II) phenanthroline, and thionine. Mixtures of two or more of the foregoing may be used. The concentration of the indicator dye in the pellet 20 or 120 may be from about 0.05 to about 5 mg per gram of base medium, or from about 0.5 to about 2 mg per gram.

The contrast dye provides an indication that exposure to VHP has been achieved and shows a color that is not indicative of lissamine green. The contrast dye may comprise phenol red or metacresol purple. Other contrast dyes that may be used to contrast against the original color of lissamine green may include bromophenol blue, thymolphthalein, bromothymol blue, thymol blue, bromocresol purple, malachite green oxalate or other indicators that may show a red/pink to yellow coloration in the base medium. The concentration of the contrast dye in the pellet 20 or 120 may be from about 0.05 to about 5 mg per gram of base medium, or from about 0.5 to about 2 mg per gram.

A useful dye composition may comprise about 2 mg of lissamine green, about 5 mg of phenol red or M-cresol purple, and about 5g of PEG (molecular weight of about 1500 to about 2000) as the base medium.

The wicking material 16 or 116 may comprise a non-cellulose porous material that is capable of wicking a liquid by capillary action. The wicking material 16 or 116 may be made of nylon, polyethersulfone (PES), polyvinylidene fluoride (PVDF), and Teflon (polytetrafluoroethylene). Cellulosic materials are avoided due to adverse reactions (potential flammability issues) to VHP. The wicking material 16 may be in the form of a rectangular strip with a length in the range from about 0.6 to about 13 cm, or from about 2.5 to about 9 cm, and a width in the range from about 0.3 to about 1.5 cm, or from about 0.3 to about 1 cm. The wicking material 116 may be in the form of a circular layer with a diameter in the range from about 2 to about 10 cm, or from about 5 to about 10 cm. The wicking material 16 or 116 may have a thickness in the range from about 5 to about 500 micrometers, or from about 50 to about 250 micrometers. The wicking material 16 or 116 may have an average pore size in the range from about 0.1 to about 5 micrometers, or from about 0.1 to about 3 micrometers, or from about 0.1 to about 1 micrometers, from about 0.1 to about 0.7 micrometers, or about 0.2 to about 0.6 micrometers, or about 0.3 to about 0.5 micrometers, or about 0.4 to about 0.5 micrometers, or about 0.45 micrometers.

The wicking material 16 or 116 is placed in contact with or nearly in contact with the pellet 20 or 120, respectively. In use, the pellet 20 or 120 is melted. The wicking material 16 or 116 absorbs the melted dye composition and carries the dye composition along the wicking material 16 or 116 so long as the temperature is high enough (i.e., about 45° C. to about 65° C.). The time required for the dye composition to move a certain fixed distance, for example, from “FAIL” to “PASS,” and to change color is dependent on temperature and hydrogen peroxide concentration. Once the dye composition has reached a certain distance, for example, “PASS” as indicated in FIG. 1, and the color has changed to a predetermined color, it is assumed that the environment being tested has undergone a desired level of sterilization, for example, the probability that all of the microbes in the environment being tested (e.g., a sterilization chamber) have been killed is, for example, 0.99999.

The chemical indicator 10 or 110 may be used in a VHP sterilization process to indicate whether desired sterilization parameters of temperature and VHP concentration have been achieved. The article to be sterilized, for example, a medical device, and the chemical indicator 10 or 110 are placed in a VHP sterilization unit and subjected to VHP sterilization. The sterilization unit may be a VPro 60, VPro Max or a VPRO S2 sterilizer, each of which is available from STERIS. The sterilization unit may also be a STERRAD 100 or STERRAD 100NX available from American Sterilization Products.

Current chemical indicators for VHP sterilization processes are static, color changing devices. In contrast, the chemical indicator provided for herein is a moving front chemical indicator. The ability of an indicator to show a moving front response to multiple factors of the VHP sterilization process reduces the need for interpretation by end users and allows for the possibility of Type 5 or Type 6 chemical indicators.

### EXAMPLES

Prototype chemical indicators are made by cutting slices of wicking material of the appropriate composition and tacking them onto a polyester surface with rubber cement. The wicking material is a polyethersulfone (PES) filter material with an average pore size of 0.45 micrometers. A small quantity (approximately 60 mg) of a dye composition comprising a base medium and an indicator dye and optionally a contrast dye is dripped onto the end edge of the wicking material and allowed to dry. These samples are subjected to VHP lumen or non-lumen cycles in either a VPro 60 or VProMax VHP sterilizer. Color changes and distance traveled are measured. Samples are also exposed to a dry heat oven for the same time period as a VHP lumen cycle (about 55 minutes). The formulations that are tested are shown in Table I. The movement results of the directed flow runs are shown in Table 2.

TABLE 1

| Formulation | | | | |
|---|---|---|---|---|
| Number | Indicating dye | Contrast dye | Base medium | Color |
| 1 | Lissamine | Bromothymol Blue, | PEG2000, 5 g | Green |
| | Green, 2 mg | 7.5 mg | | |
| 2 | Lissamine | Phenol Red, 5.0 mg | PEG2000, 5 g | Green |
| | Green, 3.2 mg | | | |
| 3 | Lissamine | Thymol Blue, Na | PEG2000, 5 g | Dk. Blue |
| | Green, 2.7 mg | salt, 4.7 mg | | |
| 4 | Lissamine | Thymolphthalein, | PEG2000, 5 g | Green |
| | Green, 3.1 mg | 4.8 mg | | |
| 5 | Lissamine | M-cresol Purple, | PEG2000, 5 g | Green |
| | Green, 3.5 mg | Na Salt, 4.8 mg | | |
| 6 | Lissamine | Bromophenol Blue, | PEG2000, 5 g | Dk. Blue |
| | Green, 2.7 mg | 7.8 mg | | |
| 7 | Resazurin, 5 mg | none | PEG1500, 5 g | Dark blue |
| 8 | Diphenylamine | Phenol Red, 5 mg | PEG1500, 6.7 g | Yellow |
| | sulfonate, 6.7 mg | | | |
| 9 | Lissamine | Phenol Red, 5 mg | PEG1500, 5 g | Dark Teal |
| | Green, 2 mg | | | |
| 10 | Lissamine | Bromocresol | PEG1500, 5 g | Dark Teal |
| | Green, 5 mg | Purple, 5 mg | | |
| 11 | Lissamine | M-cresol Purple, | PEGMME 1900, 5 g | Dark Teal |
| | Green, 7 mg | 5 mg | | |
| 12 | Lissamine | Malachite Green | PEGMME 1900, 2.49 g | Blue |
| | Green, 2.1 mg | Oxalate, 10.6 mg | plus PEG1500, 2.49 g | |
| 13 | Lissamine | none | PEG2000, 5 g | Blue |
| | Green, 2 mg | | | |

TABLE 2

| Test | Formulation | | Sub- | Distance | | Color |
|---|---|---|---|---|---|---|
| Number | Number | Cycle Type | strate | traveled | | change |
| A | 1 | Oven, 55 min, | PES | NA | | Green |
| | | 50° C. | | | | |
| | 2 | Oven, 55 min, | PES | NA | | Green |
| | | 50° C. | | | | |
| | 3 | Oven, 55 min, | PES | NA | | Green |
| | | 50° C. | | | | |
| | 4 | Oven, 55 min, | PES | NA | | Lt. Blue |
| | | 50° C. | | | | |
| | 5 | Oven, 55 min, | PES | NA | | Green |
| | | 50° C. | | | | |
| | 6 | Oven, 55 min, | PES | NA | | Blue |
| | | 50° C. | | | | |
| | 1 | Lumen, 55 min | PES | — | | Yellow |
| | 2 | Lumen, 55 min | PES | 2.4 | cm | Yellow |
| | 3 | Lumen, 55 min | PES | 2.8 | cm | Yellow |
| | 4 | Lumen, 55 min | PES | 2.4 | cm | — |
| | 5 | Lumen, 55 min | PES | 2.7 | cm | Yellow |
| | 6 | Lumen, 55 min | PES | 2.4 | cm | Blue |
| B | 1 | Non-Lumen, | PES | 1.8 | cm | Yellow |
| | | 28 min | | | | |
| | 2 | Non-Lumen, | PES | 1.4 | cm | Yellow |
| | | 28 min | | | | |
| | 3 | Non-Lumen, | PES | 2.1 | cm | Yellow |
| | | 28 min | | | | |
| | 4 | Non-Lumen, | PES | 1.1 | cm | Gold |
| | | 28 min | | | | |
| | 5 | Non-Lumen, | PES | 1.9 | cm | Yellow |
| | | 28 min | | | | |
| | 6 | Non-Lumen, | PES | 1.4 | cm | Dk. Blue |
| | | 28 min | | | | |
| C | 7 | Lumen | PES | 2.1 | cm | none |
| | 8 | Lumen | PES | 1.8 | cm | none |
| D | 7 | Non-lumen | PES | 2.5 | cm | none |
| E | 9 | Lumen | PVDF | 1.1 | cm | Yellow |
| | 10 | Lumen | PVDF | 1 | cm | Yellow |
| | | | | | | green |
| | 11 | Lumen | PVDF | 1 | cm | Yellow |
| | 12 | Lumen | PVDF | 1.1 | cm | Colorless |
| | 9 | Lumen | PES | 1 | cm | Yellow |
| | 10 | Lumen | PES | 1.7 | cm | Yellow |
| | | | | | | green |
| | 11 | Lumen | PES | 1 | cm | Yellow |
| | 12 | Lumen | PES | 1.5 | cm | Colorless |
| | 13 | Lumen | PES | 1.5 | cm | Colorless |
| F | 9 | Lumen | PES | 1.7-2 | cm | Yellow |
| | 9 | Lumen | PES | 1.5 | cm | Yellow |

A useful indicator comprises 2 mg of lissamine green and 5 mg of phenol red or m-cresol purple in combination with 5 grams of a PEG-containing base medium.

The formulations disclosed above are suitable for use in a Type 5 or Type 6 VHP indicator.

While the invention has been explained in relation to various embodiments, it is to be understood that various modifications thereof will become apparent to those skilled in the art upon reading the specification. Therefore, it is to be understood that the invention disclosed herein includes any such modifications that may fall within the scope of the appended claims.

1. A chemical indicator, comprising:
a non-cellulosic backing layer;
a non-cellulosic cover layer overlying the backing layer;
the backing layer and/or the cover layer comprising a gas permeable polymeric film;
a non-cellulosic wicking material positioned between the backing layer and the cover layer;
a dye composition positioned between the backing layer and the cover layer and in contact with or nearly in contact with the wicking material, the dye composition comprising an indicator dye which changes color in the presence of hydrogen peroxide, and a base medium, which melts at a temperature in the range from about 45° C. to about 65° C.;
the cover layer including a transparent portion to permit observation of the wicking material; and
an adhesive for adhering the cover layer to the backing layer.

2. The chemical indicator of claim 1 wherein the backing layer includes a depression for receiving the wicking material and the dye composition.

3. The chemical indicator of claim 1, wherein the backing layer comprises a metallic foil, a polyolefin, polyester, polyamide, vinyl chloride polymer, polyacrylate, polycarbonate, or a mixture of two or more thereof.

4. The chemical indicator of claim 1, wherein the backing layer comprises polyethylene, polypropylene, polyethylene terephthalate, copolymers of polyethylene terephthalate, polybutylene terephthalate, polyvinyl chloride, polyvinylidene fluoride, ethylene vinyl alcohol, ethylene vinyl acetate, polychloroprene, polyisoprene, polytetrafluoroethylene, poly (trifluorochloroethylene), polymethacrylate, poly (meth) methacrylate, or a mixture of two or more thereof.

5. The chemical indicator of claim 1 wherein the backing layer comprises an aluminum foil.

6. The chemical indicator of claim 1, wherein the cover layer comprises a polyolefin, polyester, polyamide, vinyl chloride polymer, polyacrylate, polycarbonate, or a mixture of two or more thereof.

7. The chemical indicator of claim 1, wherein the cover layer comprises polyethylene, polypropylene, polyethylene terephthalate, copolymers of polyethylene terephthalate, polybutylene terephthalate, polyvinyl chloride, polyvinylidene fluoride, ethylene vinyl alcohol, ethylene vinyl acetate, polychoroprene, polyisoprene, polytetrafluoroethylene, poly (trifluorochloroethylene), polymethacrylate, poly (meth) methacrylate, or a mixture of two or more thereof.

8. The chemical indicator of claim 1, wherein the cover layer comprises polypropylene.

9. The chemical indicator of claim 1 wherein the backing layer is gas permeable to permit vaporous hydrogen peroxide to pass through the backing layer and contact the wicking material.

10. The chemical indicator of claim 1 wherein the cover layer is gas permeable to permit vaporous hydrogen peroxide to pass through the cover layer and contact the wicking material.

11. The chemical indicator of any onc of the preceding claim 1 wherein the base medium comprises polyethylene glycol, polyethylene glycol monomethyl ether, a eutectic solid, an ionic liquid, a wax, a thermoplastic polymer, or a mixture of two or more thereof.

12. The chemical indicator of claim 1 wherein the indicator dye comprises a redox indicator which reacts in the presence of hydrogen peroxide.

13. The chemical indicator of claim 1 wherein the indicator dye comprises lissamine green, resazurin, resorufin, diphenylamine sulfonate, diphenylamine, nitrodiphenylamine, methyl orange, neutral red, methylene blue, crystal violet, iron(II) phenanthroline, thionine, or a mixture of two or more thereof.

14. The chemical indicator of claim 1 wherein the dye composition further comprises a contrast dye.

15. The chemical indicator of claim 14 wherein the contrast dye comprises phenol red, metacresol purple, bromophenol blue, thymolphthalein, bromothymol blue, thymol blue, bromocresol purple, malachite green oxalate, or a mixture of two or more thereof.

16. The dye composition of claim 1 wherein the dye composition is in the form of a pellet.

17. The chemical indicator of claim 1 wherein the wicking material comprises nylon, polyethersulfone, polyvinylidene fluoride, polytetrafluoroethylene, or a mixture of two or more thereof.

18. The chemical indicator of claim 1 wherein the wicking material has an average pore size in the range from about 0.1 to about 5 micrometers, or from about 0.1 to about 3 micrometers, or from about 0.1 to about 1 micrometers, or from about 0.1 to about 0.7 micrometers, or about 0.2 to about 0.6 micrometers, or about 0.3 to about 0.5 micrometers, or from about 0.4 to about 0.5 micrometers, or about 0.45 micrometers.

19. The chemical indicator of claim 1 wherein the wicking material is in the form of a rectangular strip.

20. The chemical indicator of claim 1 wherein the wicking material is in the form of a circular layer.

21. The chemical indicator of claim 1 wherein upon exposure of the chemical indicator to vaporous hydrogen peroxide at a temperature in the range from about 45° C. to about 65° C., the base medium melts and the dye composition wicks along the wicking strip and changes color in response to exposure to the vaporous hydrogen peroxide.

22. The chemical indicator of claim 1 wherein the chemical indicator is a moving front chemical indicator.

23. A process for conducting a vaporous hydrogen peroxide sterilization process, comprising: exposing an article to be sterilized and the chemical indicator of claim 1 to vaporous hydrogen peroxide at a temperature in the range from about 45° C. to about 65° C.
